(19) United States
(12) Patent Application Publication
(10) Pub. No.: US 2019/0103996 A1
(43) Pub. Date: Apr. 4, 2019

(54) LTE Channel Estimation

(71) Applicant: SEQUANS COMMUNICATIONS S.A., Colombes (FR)

(72) Inventors: Hugo LIME, Colombes (FR); Moussa ABDI, Colombes (FR); Serguei BURYKH, Colombes (FR); Serdar SEZGINER, Colombes (FR)

(21) Appl. No.: 15/721,172

(22) Filed: Sep. 29, 2017

(51) Int. Cl. H04L 25/02; H04L 1/00

(52) U.S. Cl. CPC H04L 25/0256; H04L 1/0045

(57) ABSTRACT

A method for channel estimation in LTE, the method comprising decoding a received LTE signal comprising a message, and when a CRC of the decoder indicates successful decoding of a subframe, estimating the content of the message transmitted to the decoder, de-rotating the received LTE signal based on the estimated content of the message transmitted to the decoder to calculate pseudo pilot signals for all resource elements on which the corresponding physical downlink shared channel ‘PDSCH’ is mapped.

### TECHNICAL FIELD

This invention relates to channel estimation in LTE. It is particularly suitable for, but by no means limited to, channel estimation for enhanced machine-type communications (eMTC) and narrowband internet-of-things (NB-IoT) in LTE.

### BACKGROUND

An important part of the receiver chain in LTE is channel measurement. The main use of channel measurement is to estimate the channel for all Resource Elements (REs) in order to enable coherent demodulation at the receiver to compensate for the impact of the channel. Measurement of the signal power, noise power, timing, Doppler frequency, phase error and Channel Quality Indicator (CQI) are also important receiver operations.

LTE provides Cell-specific Reference Signals (CRSs) as explained in section 6.10.1 of the 3GPP TS 36.211 V13.4.0. These CRSs are pilot signals which are mapped in some Resource Elements. FIG. 1 shows an example of this mapping of RO pilot signals (10) as defined by the 3GPP specification for antenna port 0. The x-axis is time domain representing the OFDM symbol index, 0-13, for a given subframe. The y-axis is frequency domain representing the subcarrier index, 0-11 as would be understood.

The quality of the measurements derived by the receiver depend on the ability to remove the noise (thermal noise and interference) on the (CRS) pilot signals (10), especially at low SNR. This ability is directly linked to the number of pilot signals used for filtering. The noise power reduction factor is approximately equal to the number of CRSS, N_{CRS} used:

$${σ}_{filtered}^{2} \approx \frac{{σ}^{2}}{{N}_{CRS}} .$$

In LTE, for each antenna port, there are only 4 CRSs for each Resource Block (RB) on the available REs (for example there are 84 REs available when there are 7 OFDM symbols in a given RB as there are 7 OFDM symbols×12 subcarriers=84).

Moreover, as would be understood, the channel varies over time, and so it is important to carry out the channel measurements by using signals sent very close to each other in time. For LTE Cat-M1 devices, the narrowband is restricted to 6 RBs per slot (per half of each subframe) which limits the number of CRSs available (4×6=24 per slot). The channel may also vary in frequency, and therefore it is also important to use signals sent at similar frequencies (nearby subcarriers).

Therefore, it is known that being able to increase the number of pilot signals (CRS) used for channel measurements while using only signals sent in nearby OFDM symbols and frequency greatly improves the reliability and accuracy of the measurements.

There are several known solutions for improving the channel estimation using the decoded data. Most of these solutions work in an iterative way: they use the estimated decoded bits to re-estimate the channel coefficients and then try to decode the bits again. Problems exist with this way of proceeding:
The added complexity is large because the decoding process must be run multiple times.
The re-estimation of the channel coefficients is based on the estimated decoded bits which could lead to error propagation.

Another known technique is to create pseudo pilot symbols using the control channel (first symbols of the subframe). These pseudo pilots are then used to calculate the channel estimates of the data symbols. The issue with this solution is that the control channel is actually mapped to a small portion of the subframe thus enabling the creation of only a small number of pseudo pilot signals. Moreover, for eMTC devices, the mapping of the control channel has been changed and it is transmitted over the same allocation as data hence the mapping of the current MTC physical downlink control channel (MPDCCH) is much more complicated and not fixed (it can also hop in frequency), making this use of pseudo pilot symbols too complex.

There is therefore a need for an improved channel estimation tailored technologies such as for eMTC and NB-IoT.

### SUMMARY

According to a first aspect there is provided a method as defined in claim 1 of the appended claims. Thus there is provided a method for channel estimation in LTE, the method comprising decoding a received LTE signal comprising a message, and when a CRC of the decoder indicates successful decoding of a subframe, estimating the content of the message transmitted to the decoder, de-rotating the received LTE signal based on the estimated content of the message transmitted to the decoder to calculate pseudo pilot signals for all resource elements on which the corresponding physical download shared channel ‘PDSCH’ is mapped.

Optionally, the method wherein the estimating comprises reconstructing the content of the message transmitted to the decoder by emulating the transmit chain of the eNodeB that transmitted the received signal and passing the decoded received signal through the emulated transmit chain.

Optionally, the method wherein de-rotation comprises for each symbol and subcarrier of the received signal, de-rotating using the estimated content of the message transmitted to the decoder.

Optionally, the method wherein de-rotation comprises calculating each pseudo pilot signal as

$${{h}^{`}}_{l , m} = \frac{{r}_{l , m}}{{{s}^{`}}_{l , m}} = \frac{{r}_{l , m} {{s}^{`}}_{l , m}^{*}}{{\vert {{s}^{`}}_{l , m} \vert}^{2}} .$$

Optionally, the method further comprising estimating the channel at a pre-defined time and frequency by averaging neighboring de-rotated pseudo pilot signals.

Optionally, the method further comprising reducing the noise in the cell-specific reference signals ‘CRS’ by averaging neighboring and non-overlapping de-rotated pseudo pilot signals.

Optionally, the method further comprising reducing the noise in the Doppler frequency and phase error measurements of the channel by using the pseudo pilot signals to calculate a mean correlation by averaging the correlation between all combinations of symbols carrying data spaced by a pre-defined time delay.

Optionally, the method further comprising, when in a low Doppler environment wherein the channel can be assumed to be constant between two consecutive subframes, using the channel estimation of the previous subframe when decoding the subsequent subframe if the previous subframe was successfully decoded, and using a channel estimation from the CRS of the subsequent subframe when decoding the subsequent subframe if the previous subframe was not successfully decoded.

Optionally, the method further comprising, in relation to two consecutive subframes and when in a high Doppler environment, using both the channel estimation of the previous subframe if the previous subframe was successfully decoded, and using a channel estimation from the CRS of the current subframe to decode the current subframe.

Optionally, the method further comprising, in relation to two consecutive subframes, when decoding of a previous subframe has failed and the previous subframe is located in the same narrowband as the current subframe, performing alpha filtering on the CRS of the de-rotated pseudo pilot signals to minimize the mean square error of the channel estimation.

Optionally, the method wherein the alpha filtering comprises:

$$\{ \begin{matrix}{{h}^{`}}_{k}^{filt} = α {{h}^{`}}_{k - 1}^{filt} + ( 1 - α ) {{h}^{`}}_{k} for k > 0 \\ {{h}^{`}}_{0}^{filt} = {{h}^{`}}_{0}\end{matrix}$$

with hₖ being the k^{th} CRS in the subcarrier.

Optionally, the method further comprising in relation to two consecutive subframes, when the transport block of a subsequent subframe is different to the transport block of a previous subframe, using the channel estimation of the previous subframe when decoding the subsequent subframe if the previous subframe was successfully decoded, and using a channel estimation from the CRS of the previous subframe when decoding the subsequent subframe if the previous subframe was not successfully decoded.

Optionally, the method further comprising calculating the pseudo pilot signals for subsequent subframes even if the data has been successfully decoded to allow enhanced channel estimation across transport blocks.

In a second aspect a non-transitory computer readable medium comprising computer readable instructions that when executed by a processor, cause the processor to carry out the method.

In a third aspect, a device comprising a receiver and a processor, the processor being operable to carry out the method.

With all the aspects, preferable and optional features are defined in the dependent claims.

### BRIEF DESCRIPTION OF THE DRAWINGS

The patent or application file contains at least one drawing executed in color. Copies of this patent or patent application publication with color drawings will be provided by the Office upon request and payment of the necessary fee.

Embodiments will now be described, by way of example only, and with reference to the drawings in which:

FIG. 1 illustrates an example mapping of cell-specific reference signal for antenna port 0;

FIG. 2 illustrates a decoding process of Cat-M1 in LTE;

FIG. 3 illustrates receiver backward path and de-rotation to provide pseudo pilot signals;

FIG. 4 illustrates a data channel mapping on a subframe using the FIG. 1 example of CRS;

FIG. 5 illustrates an example of averaging pilot signals to improve channel estimation;

FIG. 6 illustrates an example of averaging non-overlapping pilot signals to improve CRS;

FIG. 7 illustrates an example of correlation calculations with a pre-defined time delay, τ_{corr};

FIG. 8 illustrates use of the previous subframe improved channel estimation in a low Doppler scenario;

FIG. 9 illustrates mixed use of the previous subframe improved channel estimation and current subframe CRS-based channel estimation;

FIG. 10 illustrates improved decoding when previous subframe decoding has failed;

FIG. 11 illustrates cross-subframe channel estimation with repetitions; and

FIG. 12 illustrates a method for channel estimation in LTE.

In the figures, like elements are indicated by like reference numerals throughout.

### OVERVIEW

For single subframe decoding, re-estimating the channel is not needed where the data is already decoded. However in the context of MTC, the channel estimation of the current subframe can be helpful for future decoding. This is because for MTC devices, cross-subframe channel estimation is possible as such devices target very low Doppler and very low SNR and because frequency hopping is limited.

Accordingly, this disclosure describes a method where channel measurements are improved by increasing the number of signals used for the measurements by reconstructing the content of a message that was sent and using the reconstructed content to de-rotate the corresponding received data to provide additional pilot signals to aid channel estimation. Cross-subframe channel estimation may also be used to help decode future data.

The following is described mostly in relation to Cat-M1 (also known as eMTC). However, the disclosed method(s) can apply to any communication system having continuous communication in a given RB, for example NB-IoT, Cat-M2 (also known as feMTC).

### DETAILED DESCRIPTION

Taking Cat-M1, a low power wide area (LPWA) technology, as an example, the physical downlink shared channel (PDSCH) decoding (also known as the receiver chain) is shown in FIG. 2. The decoding process comprises two inputs, a first 20A comprising received complex signals r_{l,m} for each OFDM symbol l and subcarrier m in a given subframe as would be understood, and a second 20B comprising an estimate of the channel used to transmit. Thereafter, in order to provide the decoded data, the decoder passes the received signals through several modules comprising equalisation and soft decoding 21, descrambling 22, HARQ de rate-matching and soft combining 23, systematic/parity separation 24 (which may also be considered part of block 23), de interleaving 25, channel decoding 26 and a CRC check and removal 27 as would be understood. The decoder provides decoded data 28 and a CRC status 29 that indicates whether the data has been correctly decoded. The CRC sequence is 24 bits long in LTE and so the reliability is high as the probability of an undetected error is approx. 2²⁴ which is acceptable.

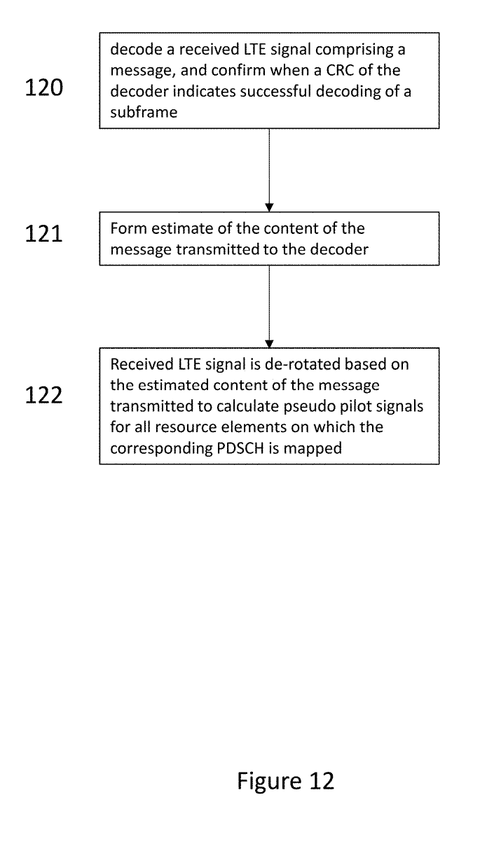

The decoding of a received LTE signal comprising a message, and confirming when a CRC of the decoder indicates successful decoding of a subframe is a first step (see FIG. 12 step 120) according to the disclosed method.

Following successful decoding, in a second step (see FIG. 12 step 121), an estimate is formed of the content of the message transmitted to the decoder as will now be described. The estimate is only produced when the previous CRC status reports successful decoding to ensure that the estimated message is precise.

The estimate is obtained by way of emulating the sending chain of the eNodeB that sent the LTE signal. Emulation of the sending chain may be carried out by providing a backward path 31 to estimate the signal sent (and hence the content of the message). FIG. 3 shows the receiver chain from FIG. 2 (30 in FIG. 3) that provides the decoded data 28 to the backward path 31. The backward path comprises CRC calculation & CRC addition 32, channel encoding 33, sub-block interleaving 34, bit collection 35, rate-matching 36, scrambling 37, bit to constellation matching 38 as would be understood. The backward path provides an estimate 39 of the message that was sent to the decoder.

The processing overhead of the backward chain 31 is very limited. For eMTC, it is less complex than the decoding chain 30 because the Turbo encoder used for channel encoding 33 is much simpler than the Turbo decoder used for channel decoding 26 as it is composed of two convolutional encoders and one interleaver. For NB-IoT, convolutional encoding is used which simplifies even further the reconstruction of the transmitted signal. Moreover, in the case of eMTC and NB-IoT devices, the transmitter's chain is simple: there is no code block segmentation and only one layer is transmitted as would be understood.

Following the forming of the estimate 39 of the content of the message transmitted, the received LTE signal 20A is de-rotated 40 based on the estimated content of the message transmitted (see FIG. 12 step 122) to calculate pseudo pilot signals 41 for all resource elements on which the corresponding physical downlink shared channel ‘PDSCH’ is mapped as will now be described.

For symbol l and subcarrier m, the received signal r_{l,m} (20A) is de-rotated 40 using the estimated sent message s′_{l,m} (39) to calculate the pseudo pilot signal (41) by way of

$${{h}^{`}}_{l , m} = \frac{{r}_{l , m}}{{{s}^{`}}_{l , m}} = \frac{{r}_{l , m} {{s}^{`}}_{l , m}^{*}}{{\vert {{s}^{`}}_{l , m} \vert}^{2}} .$$

The estimated sent message 39 comprises the received signal 20A times the channel. The received signal is removed by the above formula, leaving just the channel (pseudo pilot) signals 41.

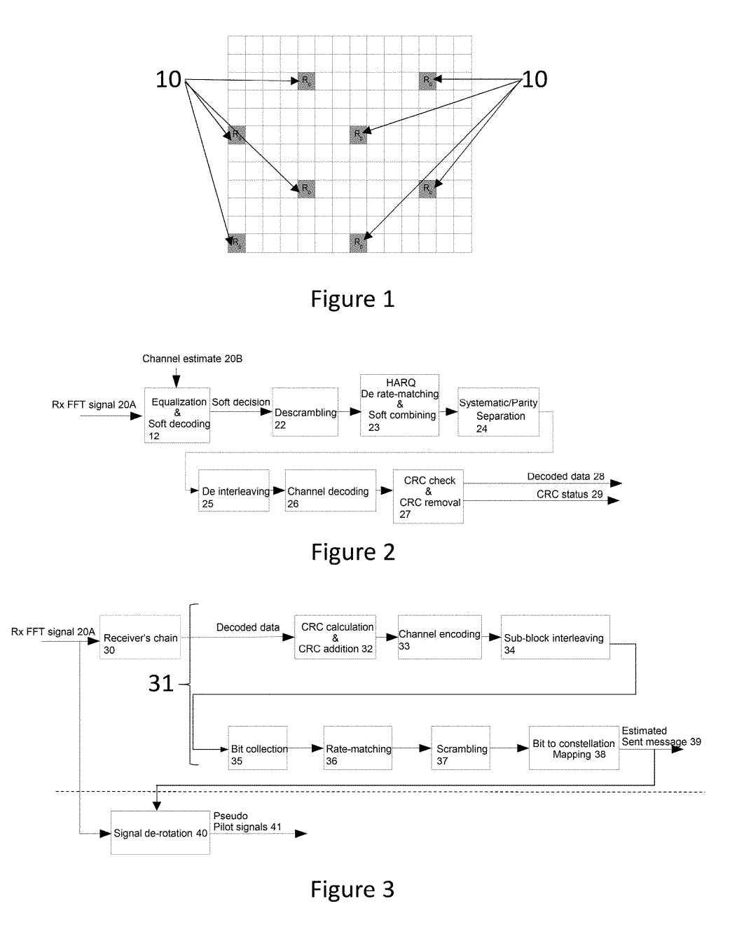

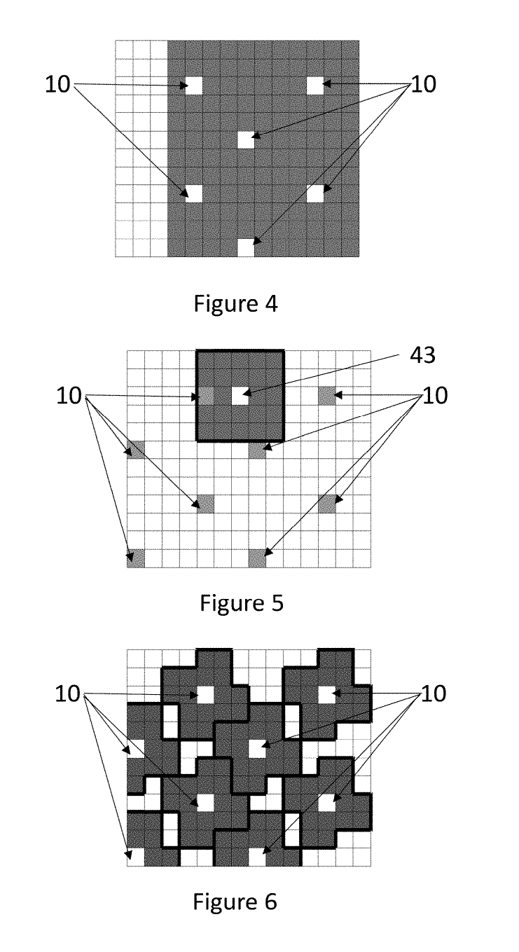

The outputs of the signal re-rotation 40 are pseudo pilot signals 41 for all REs on which the PDSCH is mapped. FIG. 4 shows such a data mapping on a subframe using the FIG. 1 example of CRS 10 where the first three symbols of each subcarrier are typically reserved for control channels. The shaded REs comprise pseudo pilot signals 41. The white REs comprise the CRS 10 of FIG. 1.

Once the pseudo pilot signals 41 have been calculated, they can be used in various scenarios to improve legacy systems, improve decoding when the previous subframe is successfully decoded in both low and high Doppler environments, improve decoding when the previous subframe decoding has failed, and help with cross-subframe channel estimation as will be explained.

### Improving Legacy Systems

Once the pseudo pilot signals 41 have been obtained, they can be used to improve channel estimation. FIG. 5 shows an example of this where 25 pilot signals (CRS 10 and pseudo pilots 41 within the shaded bordered square) are averaged. As there are many neighboring pilot signals available, the channel estimation calculation is not processor intensive. For lower signal to interference plus noise ratio (SINR) values (which may in certain situations considered to be below 5 dB) the size of the rectangle can be increased (both in time and frequency dimensions) to comprise more averaging.

When the SINR is high (which may in certain situations considered to be above 20 dB), the rectangle size can be decreased to a smaller area to reduce the time taken to average. Further, the time dimension can be increased in low Doppler scenarios (for example 0 to 10 Hz) and the frequency dimension can be increased where there is a short delay spread of the channel in question as would be understood.

As shown in FIG. 6, the CRS signals 10 may be improved (reducing the noise) by averaging the pseudo pilot signals 41 around a particular CRS 10. The noise of each CRS is kept independent of any other CRS by averaging the pseudo pilots signals 41 by way of non-overlapping portions as shown by the shaded areas within the borders on FIG. 6. Other non-overlapping shapes can be used as an alternative to that of FIG. 6. Once the CRSs are improved, the standard channel measurement algorithms may be performed. For each CRS 10, there is provided a channel estimate with less noise. In the example of FIG. 6 with 17 neighboring pilot signals, the noise reduction factor of the channel estimate is 10 log(17)≈−12 dB.

A further improvement can be made to legacy systems, specifically improving the measurement of Doppler and phase error.

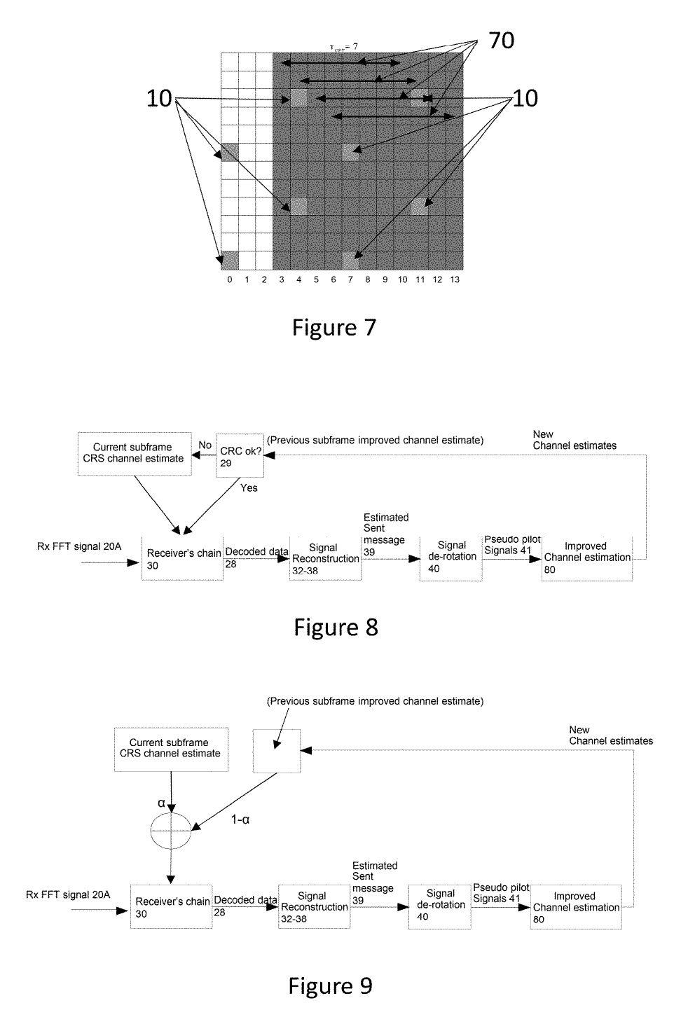

A pre-defined time delay, τ_{corr}, is used to define a number of OFDM symbols. A mean correlation is calculated by averaging the correlation between all combinations of symbols carrying data spaced by τ_{corr} as shown in FIG. 7. In the FIG. 7 example, the combinations of symbols are shown when data is sent over OFDM symbols 3 to 13 and τ_{corr}=7 (as shown by arrows 70 there are just 4 combinations of correlations to be done). In this case, the mean correlation c(7) is calculated over all subcarriers N_{sub} and is given by:

$$c ( 7 ) = \frac{1}{4 {N}_{sub}} {\sum }_{l = 3}^{6} {\sum }_{m = 0}^{{ }^{N} {sub}^{- 1}} {\hat{h}}_{l , m} {\hat{h}}_{l + 7 , m}^{*}$$

The mean correlation contains less noise than using CRS alone. By using this pre-defined time delay, a correlation distance other than the distance between CRS (pilot) carrying symbols can be used for correlation. This means the same distance can be used for each correlation computation and CRS carrying symbols do not have to be used.

By way of explanation, in order to estimate Doppler or common phase error, the channel correlation is estimated in the time domain for any τ_{corr} value. To implement such an estimation, τ_{corr} is chosen such that there are available channel estimates at a distance of τ_{corr}, a correlation is computed over a subframe, and then long term averaging of this correlation is performed. All this procedure works for a fixed predefined value of τ_{corr}.

Previously, before this disclosure, only CRS pilot symbols could be relied upon to estimate this correlation, so τ_{corr}=7 was chosen. With the techniques of this disclosure, on a sub-frame where CRC is OK, any symbol may be used, not only a CRS symbol. This also means that τ_{corr}=7 need not always be chosen. There are, therefore, more degrees of freedom for the correlation computation, specifically 1) the symbol selection is not limited to CRS carrying symbols, and 2) inter-symbol distance can be chosen independently of CRS symbol spacing.

On the other hand, as explained above, in order to obtain a reliable estimate of Doppler and Common Phase Error, we accumulate the correlation over multiple sub-frames with a fixed value of τ_{corr}, which may include successful and non-successful decoding. Since for non-successful decoding we need τ_{corr}=7, it is preferable to use τ_{corr}=7, but not mandatory.

Following successful decoding of a subframe and improving the channel estimation as per FIG. 5, the next subframe maybe decoded with the improved channel estimation. For CatM this is possible if both of the subframes in question, the previous and the subsequent are in the same narrowband. For CatM1 and NB-IoT, if frequency hopping is disabled, each subframe is always in the same narrowband as would be understood.

FIG. 8 shows a low Doppler scenario (for example 0 to 10 Hz) where the channel can assumed to be constant between two consecutive subframes. The receiver can therefore use the improved channel estimation 80 of the previous subframe without recalculation when the previous subframe was successfully decoded. If the previous subframe was not successfully decoded the receiver uses the channel estimate as provided by the CRS of the current subframe. Reference numerals as used in previous figures are re-used as appropriate.

FIG. 9 shows a scenario (for example up to 300 Hz) where a mix of the two channel estimates of FIG. 8 are used to improve the decoding of the next subframe. A linear filter, a may be used to mix the two channel estimates by choosing α∈[0,1]. The Alpha value may be adapted to the Doppler value by way of a Doppler estimator to track environment change and adapt the relevant algorithm as would be understood. Reference numerals as used in previous figures are re-used as appropriate.

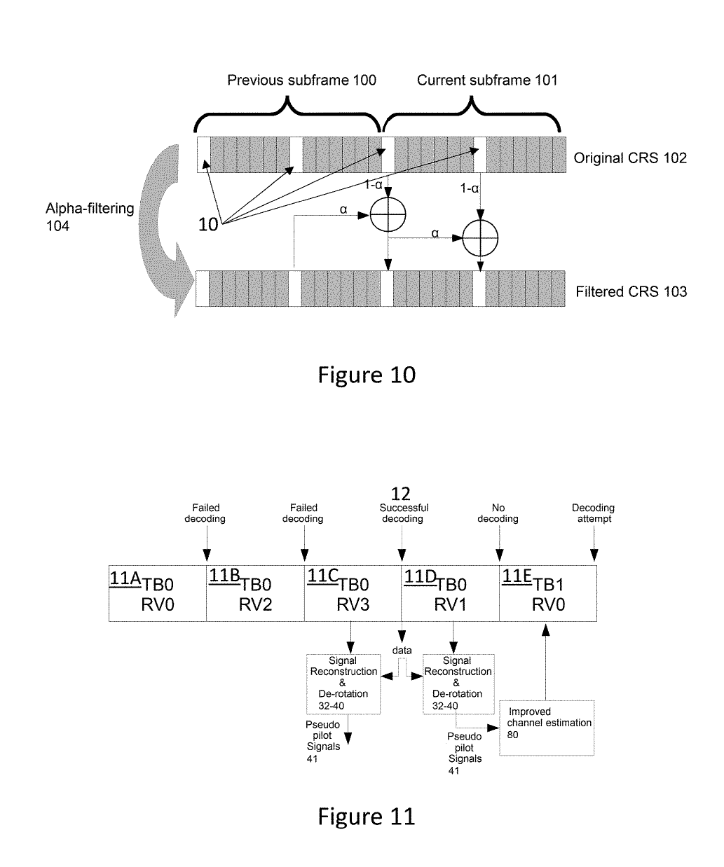

Turning to FIG. 10, in the scenario when decoding of the previous subframe 100 has failed as indicated by the CRC. With failed decoding, the use of data for channel estimation is not available, however, the CRSs are still available and can be alpha filtered (FIG. 10 shows time domain filtering) to increase the reliability of the CRS in the current subframe.

If the previous subframes are located in the same narrowband, CRS cross-subframe channel estimation can be used to improve the channel estimation and hence the decoding of the current (subsequent) subframe 101. As shown, for each subcarrier that contains CRS 10, alpha filtering is performed on the CRS. As shown, there are usually 2 CRSs (one per ‘slot’ as would be understood) that can be filtered as:

$$\{ \begin{matrix}{{h}^{`}}_{k}^{filt} = α {{h}^{`}}_{k - 1}^{filt} + ( 1 - α ) {{h}^{`}}_{k} for k > 0 \\ {{h}^{`}}_{0}^{filt} = {{h}^{`}}_{0}\end{matrix}$$

with hₖ being the k^{th} CRS in the subcarrier. The value of α∈[0,1] can be dynamically set depending on the Doppler of the environment to minimize the mean square error of the channel estimate. For example, for high Doppler, a lower value of alpha may be chosen, and for low Doppler a higher value of alpha may be chosen to take advantage of the filtered estimates.

As all previous subframes must be located on the same narrowband, the filtering is reset on each narrowband change.

FIG. 11 shows a further use for the pseudo pilot signals using an example of Mode A CatM. Subframes 11A to 11E are shown, each comprising a transport block (TBx) having a redundancy version (RVx). Once the decoding is successful 12 (on subframe 11C), the same backward path 32-39 can be employed on all subframes that carry the same TBx. As shown, pseudo pilot signals 41 can be calculated for a future subframe (11D) providing improved channel estimation as previously described without needing to complete decoding again.

Also, the improved channel estimation 80 can be used on a new transport block (TB1 of subframe 11E) by using the channel estimation to provide the pseudo pilot signals 41 on the current subframe (11E). This is because while remaining in the same RB, channel estimates as obtained in the previous subframe can be used for the next subframe (TB1 in this example).

For eMTC devices where repetition of data is received to enhance their relatively low power coverage, and where the block of repetitions spanning Nᵣₑₚ^{PDSCH} included in the group of subframes N_{abs}^{PDSCH} are located in the same narrowband, channel estimation as per 11E would also be valid. As shown in FIG. 11 in relation to subframe 11E, if the pseudo pilot signals are calculated even if the data has already been successfully decoded, a more precise channel measurement and improved channel estimation is provided. Further, even in the event that the decoding has failed, CRS cross sub-frame channel estimation as shown in FIG. 10 can still be used.

The various methods described above may be implemented by a computer program. The computer program may include computer code arranged to instruct a computer, processor and/or system to perform the functions of one or more of the various methods described above. The computer program and/or the code for performing such methods may be provided to an apparatus and/or system, such as a computer or processor, on a computer readable medium and/or a computer program product. The computer readable medium could be, for example, an electronic, magnetic, optical, electromagnetic, infrared, or semiconductor system, or a propagation medium for data transmission, for example for downloading the code over the Internet. The computer readable medium could take the form of a physical computer readable medium such as semiconductor or solid state memory, magnetic tape, punch card, a removable computer diskette, a random access memory (RAM), a read-only memory (ROM), a rigid magnetic disc, and an optical disk, such as a CD-ROM, CD-R/W, DVD or Blu-ray. The computer readable medium may comprise non-transitory media as well as transmission media.

An apparatus such as a computer or processor may be configured in accordance with such code to perform one or more processes in accordance with the various methods discussed herein. A UE may be provided comprising a processor, the processor configured in accordance with such code to perform one or more processes in accordance with the various methods discussed herein.

As has been shown, an improved method of channel estimation in LTE is provided. The improved method allows:
Improved measurements of the channel by increasing the number of pilot signals.
Improved decoding of future data in many scenarios using cross-subframe channel estimation.
It is extremely resilient to error-propagation of wrongly decoded data by using the resilient data CRC.
It is low-complexity and processor overhead due to the complexity reduction which has been standardized for IoT devices.

While example embodiments have been particularly shown and described, it will be understood by those skilled in the art that various changes in form and details may be made therein without departing from the scope of the embodiments encompassed by the appended claims.

1. A method for channel estimation in LTE, the method comprising:
decoding a received LTE signal comprising a message, and when a CRC of the decoder indicates successful decoding of a subframe;
estimating the content of the message transmitted to the decoder;
de-rotating the received LTE signal based on the estimated content of the message transmitted to the decoder to calculate pseudo pilot signals for all resource elements on which the corresponding physical downlink shared channel ‘PDSCH’ is mapped.

2. The method of claim 1 wherein the estimating comprises reconstructing the content of the message transmitted to the decoder by emulating the transmit chain of the eNodeB that transmitted the received signal and passing the decoded received signal through the emulated transmit chain

3. The method of claim 1 wherein de-rotation comprises for each symbol and subcarrier of the received signal, de-rotating using the estimated content of the message transmitted to the decoder.

4. The method of claim 3 wherein de-rotation comprises calculating each pseudo pilot signal as
$${{h}^{`}}_{l , m} = \frac{{r}_{l , m}}{{{s}^{`}}_{l , m}} = \frac{{r}_{l , m} {{s}^{`}}_{l , m}^{*}}{{\vert {{s}^{`}}_{l , m} \vert}^{2}} .$$

5. The method of claim 1 further comprising estimating the channel at a pre-defined time and frequency by averaging neighboring de-rotated pseudo pilot signals.

6. The method of claim 1 further comprising reducing the noise in the cell-specific reference signals ‘CRS’ by averaging neighboring and non-overlapping de-rotated pseudo pilot signals.

7. The method of claim 1 further comprising reducing the noise in the Doppler frequency and phase error measurements of the channel by using the pseudo pilot signals to calculate a mean correlation by averaging the correlation between all combinations of symbols carrying data spaced by a pre-defined time delay.

8. The method of claim 5 further comprising, when in a low Doppler environment wherein the channel can be assumed to be constant between two consecutive subframes, using the channel estimation of the previous subframe when decoding the subsequent subframe if the previous subframe was successfully decoded, and using a channel estimation from the CRS of the subsequent subframe when decoding the subsequent subframe if the previous subframe was not successfully decoded.

9. The method of claim 5 further comprising, in relation to two consecutive subframes and when in a high Doppler environment, using both the channel estimation of the previous subframe if the previous subframe was successfully decoded, and using a channel estimation from the CRS of the current subframe to decode the current subframe.

10. The method of claim 5 further comprising, in relation to two consecutive subframes, when decoding of a previous subframe has failed and the previous subframe is located in the same narrowband as the current subframe, performing alpha filtering on the CRS of the de-rotated pseudo pilot signals to minimize the mean square error of the channel estimation.

11. The method of claim 10 wherein the alpha filtering comprises:
$$\{ \begin{matrix}{{h}^{`}}_{k}^{filt} = α {{h}^{`}}_{k - 1}^{filt} + ( 1 - α ) {{h}^{`}}_{k} for k > 0 \\ {{h}^{`}}_{0}^{filt} = {{h}^{`}}_{0}\end{matrix}$$
with hₖ being the k^{th} CRS in the subcarrier.

12. The method of claim 5 further comprising in relation to two consecutive subframes, when the transport block of a subsequent subframe is different to the transport block of a previous subframe, using the channel estimation of the previous subframe when decoding the subsequent subframe if the previous subframe was successfully decoded, and using a channel estimation from the CRS of the previous subframe when decoding the subsequent subframe if the previous subframe was not successfully decoded.

13. The method of claim 12 further comprising calculating the pseudo pilot signals for subsequent subframes even if the data has been successfully decoded to allow enhanced channel estimation across transport blocks.

14. A non-transitory computer readable medium comprising computer readable instructions that when executed by a processor, cause the processor to carry out the method of claim 1.

15. A device comprising a receiver and a processor, the processor being operable to carry out the method of claim 1.
